(19) United States
(12) Patent Application Publication
(10) Pub. No.: US 2017/0077793 A1
(43) Pub. Date: Mar. 16, 2017

(54) ELECTRIC GENERATOR HAVING PERMANENT MAGNETS AND FITTED WITH A MAGNETIC FLUX COLLECTOR

(71) Applicant: EEL Energy, Paris (FR)

(72) Inventor: Jean Baptiste DREVET, Paris (FR)

(21) Appl. No.: 15/123,567

(22) PCT Filed: Mar. 5, 2015
(86) PCT No.: PCT/EP2015/054657

§ 371 Date: Sep. 2, 2016

(30) Foreign Application Priority Data
Mar. 5, 2014 (FR) 1451794

(51) Int. Cl. H02K 35/00; F03B 13/18; H02K 1/08

(52) U.S. Cl. CPC H02K 35/00; H02K 1/08; F03B 13/188

(57) ABSTRACT

An alternator comprising a primary portion and a secondary portion that are movable relative to each other: the primary portion comprises first and second series of magnets arranged to form an alternation of magnets from the first and second series of magnets; the secondary portion comprising a core and a coil surrounding said core. The secondary portion presents a first collector having teeth that are spaced apart in such a manner that during travel of the secondary portion relative to the primary portion in said travel direction, the alternator adopts in alternation first and second distinct configurations, the teeth of the first collector when in the first configuration facing magnets belonging to the first series of magnets, and the teeth, when in the second configuration, facing magnets belonging exclusively to the second series of magnets.

The invention relates to the field of alternators for inducing an electric voltage in a coil of a magnetic secondary portion.

### BACKGROUND OF THE INVENTION

More precisely, the invention relates to an alternator comprising a magnetic primary portion and a magnetic secondary portion that are movable relative to each other in at least one travel direction. The primary portion has first and second series of magnets, each of the magnets of the series of magnets comprising a north pole and a south pole, the magnets of the first series of magnets having their north poles oriented in the same first orientation direction, the magnets of the second series of magnets having their north poles oriented in the same second orientation direction opposite to said first orientation direction, the magnets of the first and second series of magnets being arranged in such a manner as to form an alternation of magnets from the first series of magnets and of magnets from the second series of magnets. The secondary portion comprises a core and a coil surrounding the core.

At low relative travel speeds between the primary and secondary portions, it is found that the electric voltage generated across the coil is low, and it would be advantageous to increase this electric voltage.

### OBJECT OF THE INVENTION

An object of the invention is to provide an alternator that is particularly adapted to generating electric voltages when the relative travel speed between the primary and secondary portions is low.

### SUMMARY OF THE INVENTION

In order to achieve this object, the invention relates mainly to an alternator comprising a magnetic primary portion and a magnetic secondary portion that are movable relative to each other in at least one travel direction;
the primary portion comprising first and second series of magnets, each of the magnets of the series of magnets comprising a north pole N and a south pole S, the magnets of the first series of magnets having their north poles N oriented in the same first orientation direction, the magnets of the second series of magnets having their north poles N oriented in the same second orientation direction opposite to said first orientation direction, the magnets of the first and second series of magnets being arranged in such a manner as to form an alternation of magnets from the first series of magnets and of magnets from the second series of magnets;
the secondary portion comprising a core and a coil surrounding said core.

The alternator of the invention is essentially characterized in that the secondary portion presents a first collector extending from the core between a plane in which there extends a first pole face of the coil and at least some of the magnets of the first and second series of magnets, the first collector having teeth spaced apart from one another in such a manner that during travel of the secondary portion relative to the primary portion along said at least one travel direction, the alternator adopts in alternation first and second mutually distinct configurations, the teeth of the first collector, when in the first configuration, facing respective magnets belonging exclusively to the first series of magnets, and the teeth of the first collector, when in the second configuration, facing respective magnets belonging exclusively to the second series of magnets.

In order to understand the invention, said orientation direction of a north pole of a magnet is determined by a vector (a signed axis) passing through the north and south poles of the magnet and of direction going from the south pole towards the north pole.

In order to understand the invention, the term “an alternation of magnets from the first series of magnets and of magnets from the second series of magnets” is used to mean that there is a succession of magnets taken from the first and second series of magnets, and that in this succession of magnets:
each magnet of a majority of the magnets of the first series of magnets lies between two adjacent magnets of the second series of magnets; and
each magnet of a majority of the magnets of the second series of magnets lies between two adjacent magnets of the first series of magnets.

In other words, the alternation of magnets is a repeated main pattern constituted by a magnet of the first series of magnets arranged beside a magnet of the second series of magnets.

In the first configuration, since the teeth of the first collector face respective magnets belonging exclusively to the first series of magnets, these teeth of the first collector are spaced apart from the magnets of the second series of magnets, and thus do not face the magnets of the second series of magnets.

Likewise, in the second configuration, since the teeth of the first collector face respective magnets belonging exclusively to the second series of magnets, these teeth of the first collector are spaced apart from the magnets of the first series of magnets, and thus do not face the magnets of the first series of magnets.

The alternator of the invention operates as follows:
when the alternator is in the first configuration, the teeth of the first collector are facing exclusively the magnets of the first series of magnets and they are therefore spaced apart from the magnets of the second series of magnets (in the first configuration, the mean distance between the teeth of the first collector and the magnets of the first series of magnets is less than the mean distance between these teeth and the magnets of the second series of magnets), and in this first configuration, the magnetic fluxes of the magnets of the first series of magnets facing teeth of the first collector are collected by these teeth so as to pass through the core, where they form a main magnetic flux presenting a first orientation;
when the alternator is in the second configuration, the teeth of the first collector are facing exclusively the magnets of the second series of magnets and they are therefore spaced apart from the magnets of the first series of magnets (in the second configuration, the mean distance between the teeth of the second collector and the magnets of the second series of magnets is less than the mean distance between these teeth and the magnets of the first series of magnets), and in this second configuration, the magnetic fluxes of the magnets of the second series of magnets facing teeth of the first collector are collected by these teeth so as to pass through the core, where they form a main magnetic flux presenting a second orientation that is in the opposite direction to said first orientation.

Consequently, when the primary portion is moved relative to the secondary portion, or vice versa, the alternator passes in alternation between its first and second configurations, thereby leading to variation in the magnitude and in the direction of orientation of the magnetic flux through the core of the secondary portion. Thus, for significant relative travel speeds between the primary and secondary portions, it is found that the alternation in the changes of configuration of the alternator leads to the appearance of an alternating current (AC) voltage across the terminals of the coil. This electric voltage across the terminals of the coil depends on the quantity of magnetic flux and on the speed with which the magnetic flux varies in the core. By means of the collector of the alternator of the invention, which has a plurality of pole teeth, the quantity of flux passing through the core is increased, and for a given relative travel speed between the primary and secondary portions, the speed at which the flux varies is increased.

The fact that the teeth of the first collector are spaced apart from one another in order to be placed between the coil and the alternation of magnets exclusively facing magnets of the first series of magnets (when the alternator is in the first configuration), or exclusively facing magnets of the second series of magnets (when the alternator is in the second configuration), enables a plurality of magnetic fluxes from the magnets in a given series of magnets to be collected so as to be conveyed to a common core inside the electric coil. There is no need to have as many coils as there are teeth, which is important for limiting the length of coil wire and thus limiting the electrical resistance of the coils. At a low travel speed between the secondary and primary portions, the voltage across the terminals of the coil is low. By limiting the resistance of the coil, the passage of current is facilitated, thereby causing the alternator to be better adapted to low speeds, since it limits Joule effect losses and thus increases efficiency. The relative travel speed between the primary and secondary portions is said to be “low” when the travel speed generates fewer than 10 alternations per minute between the first and second configurations.

Since the magnetic flux passing through the coil is greater than the magnetic fluxes induced individually by each magnet of a given series of magnets. The alternator of the invention also makes it possible to obtain a quantity of magnetic flux that is greater than the quantity of flux produced individually by any one of the magnets.

Furthermore, given that the flux comes from a plurality of magnets, it is collected via a plurality of teeth of the collector, so the alternator of the invention makes it possible to reduce the pole pitch between two successive magnets of a given series of magnets while amplifying the magnetic flux passing through the core by virtue of collecting flux from a plurality of magnets.

Because of the collector, it is not necessary to have one coil per tooth, and it is possible to have a single coil surrounding a single core. Compared with the situation when there is one coil per tooth, the invention makes it possible to reduce the number of coils needed, and consequently to reduce the length of electrical conductor needed for producing the winding of the alternator.

It should be observed that for a given travel speed of the secondary portion relative to the primary portion, the frequency of the electromagnetic force (emf) across the terminals of the coil depends on the number of alternations between magnets of the first and second series, i.e. on the number of alternations between the first and second configurations. This electric voltage, i.e. electromotive force (emf), is expressed by the following relationship:

emf=N*∂ç/∂t

where N is the number of turns of the coil and ∂ç/∂t is the variation of the magnetic flux in the core over time t.

Furthermore, the frequency f of the variation of the magnetic flux through the coil for travel at a constant speed of the primary portion relative to the secondary portion is determined by the following formula:

f=\dot{X}/p;

where:
f is the frequency of variation of the flux;
\dot{X} is the relative travel speed between the primary portion and the secondary portion; and
p is the pole pitch, i.e. the distance between two pole axes of successive magnets in the same series of magnets (a pole axis is the axis of symmetry of the magnet along which the north and south poles of the magnet are to be found, this pole axis passing through the north and south poles of the magnet.

Since using the collector makes it possible to reduce the pole pitch p associated with an increase in the amount of magnetic flux that is collected, it is found that for a constant speed \dot{X} of travel for the secondary portion relative to the primary portion, the invention makes it possible to increase this frequency f without being obliged to reduce the amplitude of magnetic flux variation in the core. This advantage is observed with collectors presenting a number of teeth lying in the range two and an optimum value for the number of teeth beyond which the flux leakage resulting from an increase in the number of teeth degrades the performance of the alternator. This optimum number depends on the materials and shapes selected for making the alternator. Thus, for constant travel speed \dot{X}, the invention makes it possible to increase the frequency f of variation in the emf electric voltage across the terminals of the coil, and also to increase the amplitude of this voltage.

In a preferred embodiment of the invention, the core is arranged inside the coil, the first collector extending outside the coil, a central portion of the first collector being situated between the core and some of the magnets of the first and second series of magnets and two side portions of the first collector being arranged respectively on either side of the central portion of the first collector, these side portions facing the first pole face of the coil between the coil and the magnets of the first and second series of magnets, each central or side portion of the first collector carrying at least one of the teeth of the first collector.

By means of the side portions of the first collector, the surface area of the collector facing the magnets of a given series of magnets is increased, thereby making it possible to increase the amount of magnetic flux that is collected and transferred to the core. The respective side portions of the collector are placed on either side of the central portion of the first collector and they extend outside the coil so that when the alternator is in its first configuration:
at least one tooth belonging to a side portion of the first collector extends longitudinally between the first pole face of the coil and one of the magnets of the first series of magnets; and
at least one tooth belonging to the other side portion of the first collector extends longitudinally between the first pole face of the coil and another one of the magnets of the first series of magnets.

The teeth of the first portions of the first collector are such that when the alternator is in either of its first and second configurations, each tooth of a side portion of the first collector presents a major fraction of its depth P2 extending between one of the magnets and the coil.

The teeth of the side portions of the first collector enable magnetic flux to be collected in front of and behind the central portion of the first collector while it travels in its at least one travel direction.

This characteristic of the invention makes it possible to collect magnetic flux in front of and behind the central portion of the first collector and to convey this flux to the central portion of the collector and then to the core inside the coil. In order to increase the amount of magnetic flux that is collected, there is no need to increase the size of the coil, only the length of the collector is increased by these side portions that include teeth.

In an embodiment of the invention, the coil has a second pole face, the first and second pole faces of the coil being situated on either side of the coil, the alternator further including a second collector extending around the coil from a side of the core situated beside the second pole face of the coil, a portion of the second collector having teeth spaced apart from one another in such a manner that when the alternator is in one of said first and second configurations, the teeth of the second collector then respectively face magnets belonging exclusively to one of said series of magnets. Furthermore, in this embodiment, the teeth of the first and second collectors are shaped in such a manner that when the teeth of the first collector face exclusively north poles of the magnets, then the teeth of the second collector then face exclusively south poles of the magnets, and vice versa.

In other words, when the teeth of the first collector are facing north poles exclusively, then the teeth of the second collector are facing south poles exclusively, and vice versa, and when the teeth of the first collector are facing south poles exclusively then the teeth of the second collector are facing north poles exclusively.

By means of these characteristics, the first and second collectors form a magnetic loop allowing flux to circulate between a plurality of magnet north poles and a plurality of magnet south poles, the flux from these magnets being collected by the teeth of the first and second collectors and being conveyed by the collectors to the core of the coil.

Ideally, the teeth of the second collector extend between the first pole face and a face of the alternation of magnets of the first and second series of magnets, the teeth of the second collector being spaced apart from the teeth of the first collector, and the teeth of the second collector extending between the teeth of the first collector in such a manner that when the alternator is placed in either one of its first and second configurations, the teeth of the first collector face magnets belonging to one of said first and second series of magnets, the teeth of the second collector then facing magnets belonging to the other one of said first and second series of magnets.

By having the teeth of the first and second collectors between the first pole face of the coil and one of the faces of the alternation of magnets, an alternator is obtained that is compact and that can operate with only one face of the alternation of magnets.

Ideally, the first and second collectors have the same number of teeth. Ideally, each tooth of the first and second collectors presents a magnetic flux exchange area constituted by the surface area of the tooth facing the magnet when the alternator is in either one of its first and second configurations.

Ideally, all of the flux exchange areas are equal to one another, and the sum of the exchange areas of the teeth of the first collector is equal to the sum of the exchange areas of the teeth of the second collector. This characteristic makes it possible to limit magnetic losses associated with insufficient exchange area in one of the collectors constituting the magnetic loop.

In a particular embodiment of the alternator of the invention, the magnets of the first and second series of magnets are both placed on a magnetically permeable part, the north poles of the magnets of the first series of magnets and the south poles of the magnets of the second series of magnets facing the magnetically permeable part, the teeth of the second collector being spaced apart from the teeth of the first collector, and the teeth of the second collector extending between the teeth of the first collector in such a manner that when the alternator is placed in either of its first and second configurations, the teeth of the first collector face magnets belonging to one of said first and second series of magnets, and the teeth of the second collector then face magnets belonging to the other one of said first and second series of magnets.

In this embodiment, the teeth of the first and second collectors are arranged facing a single face of the alternation of magnets of the first and second series of magnets, with the other face of this alternation facing the magnetically permeable part that supports these magnets of the alternation of magnets. This embodiment is advantageous if it is desired to minimize the overall height of the secondary portion.

The materials usable for producing the magnetically permeable part 16 of FIG. 2a or of FIG. 11c are soft iron having a low carbon content, an iron/silicon alloy, or an iron/cobalt alloy.

As an alternative to the above embodiment of the alternator, it is possible to ensure that the magnets of the first and second series of magnets form a magnet track presenting first and second opposite faces of the magnet track, the teeth of the first collector being situated facing the first face of the magnet track, and the teeth of the second collector being situated facing the second face of the magnet track, and the teeth of the first and second collectors being shaped in such a manner that when the alternator is in one of its first and second configurations, the teeth of the first and second collectors then face magnets belonging to the same one of said first and second series of magnets.

In this embodiment, the first collector faces the first face of the magnet track while the second collector extends around this magnet track in order to face the second face of the magnet track. Since the teeth of the first and second collectors are no longer interleaved, this embodiment makes it possible to reduce the space between two successive teeth of a given collector, and consequently it makes it possible to reduce the pole pitch of the alternator. It may be desirable to reduce the pole pitch when it is desired to have an alternator capable of operating at a very low relative travel speed between the primary and secondary portions (the smaller the pole pitch, the greater the increase in the frequency of the alternation between the first and second configurations).

In a preferred embodiment, the coil is wound around a core and is rectangular in shape when seen in section in a plane perpendicular to the direction of the magnetic flux passing through the core when the alternator is in one of its first and second configurations.

For a coil of given inside section, the shortest length of coil wire is obtained with a coil that is square when seen in section on a section plane perpendicular to the flux passing through the core. This ideal square shape is preferable to the conventionally circular shape, since it makes it possible to reduce the length of wire in the coil, and consequently to reduce the electrical resistance of the coil. This embodiment is particularly advantageous for a low relative travel speed between the secondary and primary portions.

In this embodiment, the core may be rectangular in shape, and preferably square, when seen in section in the plane perpendicular to the direction of the magnetic flux passing through the core when the alternator is in one of its first and second configurations. The fact that the rectangular, and preferably square, coil is formed/wound around a core that is rectangular, and preferably square, so as to limit gaps between the coil and the core, thus makes it easier to achieve the object of reducing the length of wire in the coil.

Finally, the invention provides an underwater turbine comprising a diaphragm support and a diaphragm carried by the diaphragm support, the diaphragm being arranged to undulate when it is immersed in a fluid flow. The turbine is essentially characterized in that the diaphragm is connected to at least one alternator of the invention, this connection between the diaphragm and the alternator being such that when the diaphragm undulates, it generates relative travel between the primary and secondary portions of the at least one alternator.

More generally, the alternator may be used in combination with any type of underwater turbine.

### BRIEF DESCRIPTION OF THE DRAWINGS

Other characteristics and advantages of the invention appear clearly from the following description given by way of non-limiting indication and with reference to the accompanying drawings, in which:

FIG. 1 is a perspective view of a first embodiment of an alternator 1 of the invention;

FIG. 1a shows the second collector 15 of the FIG. 1 alternator, the second collector being made by stacking laminations for passing magnetic flux between the laminations, some of the laminations being in the form of respective frames each having one side forming a tooth 10b of the second collector 15, and other laminations being in the form of respective frames that are open on one side, which laminations are shaped to define spacing between teeth;

FIG. 1b shows the core 9 of the alternator and the first collector 10 of the FIG. 1 alternator with its teeth 10a spaced apart at a constant spacing pitch Px1.

FIG. 1c shows the secondary portion 3 of the FIG. 1 alternator 1 without its second collector 15;

FIG. 2a is a section view of the FIG. 1 alternator 1, the section being in a travel plane Pc in which the secondary and primary portions 3 and 2 travel relative to each other, while the alternator is in its second configuration;

FIG. 2b is a section view of the FIG. 1 alternator 1 in a section plane in which a tooth 10a of the first collector 10 extends, the alternator being in its second configuration;

FIG. 2c is a section view of the FIG. 1 alternator in a section plane parallel to that of FIG. 2b and in which there extends a tooth 10b of the second collector 15, the alternator 1 still being in the second configuration;

FIG. 3a is a section view of the FIG. 1 alternator in the travel plane Pc while the alternator is in the first configuration with the teeth 10a facing magnets of the first series 5a and the teeth 10b facing magnets of the second series 5b;

FIG. 3b is identical to FIG. 2b, but in this figure the alternator has passed into its first configuration;

FIG. 3c is identical to FIG. 2c, but in this Figure the alternator has passed into its first configuration;

FIG. 4 shows the alternator 1 in an embodiment in which there are two secondary portions 3 and 3′ placed facing respective opposite faces of the magnet tracks 8 of the primary portion 2;

FIG. 5a is a section view of the FIG. 4 alternator in the travel plane Pc, the first secondary portion 3 of this alternator 1 being placed in the first configuration;

FIG. 5b is a view identical to the view of FIG. 5a with the second secondary portion 3′ of the alternator placed in its first configuration, i.e. its teeth 10a of its first collector are facing magnets of the first series 5a;

FIG. 5c is a view identical to the view of FIG. 5a, with the first secondary portion of the alternator placed in its second configuration;

FIG. 5d is a view identical to the view of FIG. 5a, with the second secondary portion 3′ of the alternator placed in its second configuration, these FIGS. 5a, 5b, 5c, and 5d respectively showing the successive configurations adopted by the alternator during one complete cycle of the alternator, with the opposite cycle taking place by reversing the travel direction 4;

FIG. 6a is an exploded view of the alternator of the invention in which there can be seen the teeth 10a and 10b of the first and second collectors 10 and 15 of one of the secondary portions 3, which teeth are interleaved and face the same face of the primary portion 2, in this figure the teeth of the collectors are individually detachable in order to make the alternator 1 easier to assemble;

FIG. 6b is a fragmentary section view in a travel plane A-A of the FIG. 6a alternator;

FIG. 6c shows portions of the first and second collectors 10 and 15 that are to be placed respectively facing the teeth of the collectors shown in FIGS. 6a and 6b;

FIG. 6d shows the FIG. 6a alternator in full, with the collectors of its two secondary portions 3 and 3′ assembled together;

FIG. 7a is a perspective view of an alternator of the invention in another particular embodiment in which the alternator 1 has two secondary portions 3 and 3′ placed on either side of another magnet track 17 of the primary portion 2, the first collectors of the secondary portions 3 and 3′ being formed integrally as respective single pieces comprising the collectors 10, 15 and the core 9 of the coil 11;

FIG. 7b is a side view of the FIG. 7a alternator in which it can be seen that the teeth 10a of the first collectors are offset relative to the teeth 10b of the second collectors 15;

FIG. 7c is a longitudinal section view on C-C showing the alternator of FIGS. 7a and 7b while its first secondary portion 3 is in the second configuration (magnetic flux going from the core towards the teeth of the first collector);

FIG. 7d is a cross-section view on D-D of the alternator of FIGS. 7a, 7b, and 7c, with the first secondary portion 3 still in the second configuration, and it can be seen that the magnetic loop passes from the core 9 to the teeth 10a of the first collector 10 and then passes through magnets adjacent to the magnet track of the primary portion prior to rising towards the second collector 15 of the first secondary portion 3 and finally returning to the core 9 of the first secondary portion 3;

FIG. 7e is a section view in a plane parallel to the cross-section plane D-D showing the alternator and in which it can be seen that in the embodiment of the alternator of FIGS. 7a to 7e the teeth 10a of the first collector of a given secondary portion 3 extend in planes that are different from the planes in which the teeth of the second collector 15 of the same given secondary portion 3 extend, a fraction of the magnetic loop passing via adjacent magnets of the magnet track 17 visible in FIG. 7c;

FIG. 8a is a perspective view of a part of an alternator of the invention, this alternator being in another particular embodiment in which the alternator 1 has firstly two secondary portions 3 and 3′ placed on either side of a magnet track 17 of a first primary portion 2, and secondly two other secondary portions 3″ and 3′″ placed on either side of another magnet track 17′ of a second primary portion 2′;

FIG. 8b is a longitudinal section on B-B of two secondary portions 3 and 3′ placed on either side of one of the two primary portions 2 of the FIG. 8a alternator;

FIG. 8c is a plan view of the FIG. 8a alternator in which it can be seen that the two magnet tracks 17 and 17′ are mutually parallel and extend in a common plane;

FIG. 8d is a perspective view showing the entire alternator shown in part in FIGS. 8a, 8b, and 8c, this figure showing two of the secondary portions 3 and 3″ respectively facing two mutually parallel magnet tracks 17 and 17′ and connected together by a part in the form of a plate 35 so as to provide magnetic continuity between these two first secondary portions 3 and 3″, and there can also be seen two other ones 3′ and 3′″ of the four secondary portions respectively facing the two parallel magnet tracks 17 and 17′ and connected together by another part 35′ in the form of a plate so as to provide magnetic continuity between these two secondary portions 3′ and 3′″, a magnetic loop thus being capable of passing via these four secondary portions 3, 3′, 3″, 3′″ by crossing through the two magnet tracks 17 and 17′;

FIG. 8e is a longitudinal section view on E-E of the FIG. 8d alternator and it shows that each tooth of the first collectors of the secondary portions 3, 3′, 3″, 3′″ respectively placed facing the same magnet track all face the same first or second series of magnets of the magnet track;

FIG. 8f is a cross-section view on F-F of the alternator of FIGS. 8d and 8e, this section plane F-F being perpendicular to the section plane E-E, it being clear that in this section plane F-F the magnetic loop formed at a given instant in the alternator 1 passes via its four secondary portions 3, 3′, 3″, 3′″ and via the two magnet tracks 17 and 17′ of the primary portions which have their series of magnets mutually offset so as to make possible this magnetic looping that changes direction in alternation during simultaneous travel of the secondary portions relative to the primary portions;

FIG. 9 shows a particular embodiment of the alternator 1 of the invention in which the primary portion 2 is in the form of a stack of magnets 6, each being in the form of a disk with a hollow center and having north and south poles oriented radially (the magnets of the first series 5a having their north poles oriented towards the outside of the primary portion, the magnets of the second series 5b having their north poles oriented towards the inside of the primary portion), in this figure the mutually identical secondary portions 3 are arranged in a star configuration around the primary portion 2, with the magnets 6 of the alternation 8 of stacked magnets being mutually separated or spaced apart by spacers 14, each magnet 6 facing a tooth 10a of a first collector 10 being spaced apart from the teeth 10b of the second collector 5, and vice versa, each magnet 6 facing a tooth 10b of the second collector 15 is spaced apart from the teeth 10a of the first collector 15, and in this figure voltage is generated across the terminals of the coils 11 during travel of these secondary portions relative to the single primary portion 2 along a longitudinal axis of the stack of magnets, with this stack being free to rotate without giving rise to any change of configuration for the alternator 1, with only movement in translation leading to changes of configuration;

FIG. 10 shows an embodiment of the invention that is substantially similar to the embodiment of FIG. 9, but in this embodiment each second collector 3 is connected to the corresponding core via a curved portion 20 parallel to the stack of disk-shaped magnets 6, this embodiment serving to optimize the shape of the collector so as to increase the weight-to-power ratio of the alternator compared with the alternator of FIG. 9 in which the second collectors 3 are prismatic;

FIG. 10a is a longitudinal section view of the FIG. 10 alternator 1 in a section plane containing the axis of revolution of the stack of magnets 6, in this figure it can be seen that regardless of the configuration adopted by the alternator 1 for each given secondary portion 3, when the teeth 10a of the first collector 10 are facing exclusively magnets 6 of one of the series 5b of magnets of the primary portion 2, then the teeth 10b of the second collector 3 are exclusively facing magnets of the other series 5a of magnets, with magnetic flux F passing between the teeth 10a and 10b by passing through at least two spacers 14 and at least three adjacent magnets;

FIG. 10b is a cross-section view of the alternator 1 of FIGS. 10 and 10a in a section plane in which there can be seen the secondary portions 3 distributed around the primary portion 2, this figure showing that the teeth 10a of the first collector 10 and the teeth 10b of the second collectors 15 all extend in planes perpendicular to the axis of revolution of the alternator, but that for any given secondary portion 3, it can be seen that the tooth 10a of the first collector 10 extends in a plane that is spaced apart from the plane in which the teeth 10b of the second collector 15 extend, with these two planes being at a distance apart such that when the teeth 10a are facing exclusively magnets of one of the first and second series, then the teeth 10b of the second collector are necessarily facing exclusively magnets of the other one of the first and second series, and each tooth 10a of the first collector adjacent to a tooth 10b of the second collector 15 is necessarily facing adjacent magnets of the alternation of magnets 6;

FIG. 10c is a cross-section view of the alternator of FIGS. 10, 10a, and 10b in a section plane parallel to that of FIG. 10c, but in which the teeth 10b of the second collectors 15 extend, and once more it can be seen that the teeth 10a and 10b are offset in the magnet stacking direction so that respectively they face magnets belonging to the different series 5a and 5b of magnets 6, with this figure showing how continuity is achieved for the magnetic loop visible in FIGS. 10a and 10b, each magnetic loop extending between the primary portion 2 and a secondary portion 3 presenting a fraction that extends axially in the primary portion 2 and along the stack of magnets 6;

FIG. 11 shows an alternator of the invention in which a primary portion 2 of cylindrical shape is mounted to rotate relative to a secondary portion 3 about an axis of rotation X-X coinciding with the axis of revolution of the primary portion 2; in this figure the magnets 6 are in the form of bars and they are arranged at the periphery of the primary portion 2, parallel to the axis X-X, the magnets of the first and second series of magnets being arranged in alternation with their pole axes being radial relative to the axis X-X, the magnets of the first series 5a having their south poles oriented towards the inside of the primary portion, i.e. towards the axis X-X, and their north poles oriented towards the outside of the primary portion, while the magnets of the second series 5b have their north poles oriented towards the inside of the secondary portion and their south poles oriented towards the outside;

FIG. 11a is an exploded perspective view of one of the two secondary portions 3 of the FIG. 11 alternator 1 (these secondary portions being identical to each other), this secondary portion 3 being designed to be placed facing the curvature of the cylindrically-shaped primary portion 2, and for this purpose the secondary portion has its teeth 10a and 10b of the respective first and second collectors parallel to the axis X-X in order to be able to exchange magnetic flux F between the teeth of the secondary portion and the magnets 6;

FIG. 11b is a section view of the FIG. 11 alternator in which only one of the two secondary portions 3 is shown; in this figure it can be seen that the second collector 15 forms metal loops (a loop is a frame) around the coil 11, each of these loops being formed on one side by teeth 10b of the second collector and on an opposite other side by part of a plate 35 connected to the core 9 that is itself placed inside the coil 11;

FIG. 11c is a cross-section view of the FIG. 11b alternator on a section plane K-K; this figure shows the alternation of magnets 6 of the first and second series 5a and 5b of magnets and the teeth 10a of the first collector 10 which collects the flux F leaving the north poles of the magnets of the first series 5a so as to bring it towards the core 9, and the teeth 10b of the second collector 15 that share the flux F leaving the core 9 among the south poles of the magnets of the second series of magnets 5b;

FIG. 11d is a cross-section view of the FIG. 11b alternator on a section plane J-J passing through an axial end of the second collector 15, in this figure it can be seen that the flux F leaving the core transits towards the teeth 10b of the second collector so as to return towards the south poles of the magnets of the second series 5b of magnets;

FIG. 11e is identical to FIG. 11b, but in this figure the alternator is not in the first configuration as in FIGS. 11b, 11c, 11d, but rather it is in the second configuration, and specifically in FIG. 11b, the primary portion 2 has pivoted relative to the secondary portion 3 in the travel direction 4 (in this example the travel direction is a counterclockwise direction), the teeth 10a of the first collector 10 now facing magnets 6 of the second series 5b of magnets and the teeth 10b of the second collector 15 facing magnets 6 of the first series 5a of magnets, so that the alternator 1 has changed configuration and the direction of the magnetic flux F is reversed relative to the flux F in FIGS. 11b, 11c, and 11d;

FIG. 11f is a section view on K-K of the alternator of FIGS. 11b and 11e while it is in the second configuration, the flux F being reversed relative to the flux F visible in FIG. 11c;

FIG. 11g is a section view on J-J of the alternator of FIGS. 11b and 11e while it is in the second configuration, the flux F being reversed relative to the flux F visible in FIG. 11d;

FIG. 12 shows another embodiment of the alternator 1 of the invention, and in this figure the relative movement between the secondary and primary portions 3 and 2 is movement in translation in a travel direction 4, and in this embodiment the secondary portion still includes a first collector 10 situated between the core 9 and the alternation of magnets 6, this first collector 10 still presenting teeth 10a oriented facing the alternation of magnets 6 so as to be placed selectively facing only one of the series of magnets, this secondary portion 3 presenting a second collector 15 that extends from the other end of the core 9 and that passes on either side of the peripheral coil 11 of the core 9 so as to face magnets of the alternation 8 of magnets, the teeth 10b of the second collector 15 facing the same magnets as those facing the teeth 10a of the first collector; each of these magnets 6 facing a tooth 10a and a tooth 10b is placed between the teeth 10a and 10b; the magnetic flux F is shared between the teeth 10a and 10b and crosses through the magnet track 17 passing only through magnets of a given series of magnets; the magnets 6 of the alternation in this example being separated from one another by spacers 14;

FIG. 12a is a longitudinal section view of the FIG. 12 alternator on a cross-section plane of the magnets 6, which are in the form of parallel bars extending in a plane, and in this figure it can be seen that each magnet placed facing one of the teeth 10a also faces one of the teeth 10b, these teeth 10a and 10b facing opposite north and south poles of the magnets thus providing magnetic looping through the magnets and collecting flux F for passing through the core 9;

FIG. 12b is a cross-section view of the FIG. 12 alternator in a section plane perpendicular to the travel direction 4 and in which one of the magnets 6 of the alternation of mutually parallel magnets extends lengthwise;

FIG. 12c is a view identical to the view of FIG. 12a, but in this figure the secondary and primary portions 3 and 2 have been shifted relative to each other by travel in the direction 4; unlike FIGS. 12a and 12b, which show the alternator in the first configuration with the teeth of the first and second collectors 10 and 15 exclusively facing magnets of the first series 5a of magnets, in this figure the alternator 1 is in the second configuration with the teeth of the first and second collectors 10 and 15 facing exclusively magnets 6 belonging exclusively to the second series 5b of magnets 6; in this figure it can be seen that the magnetic flux F is in the opposite direction to that shown in FIG. 12a;

FIG. 12d is a cross-section view of the FIG. 12 alternator, identical to the section of FIG. 12b except that the alternator in this figure is in the second configuration, the magnet in section in this figure forming part of the second series 5b of magnets;

FIG. 13 is a perspective view of an underwater turbine of the invention comprising a plurality of alternators 1 of the invention installed along a diaphragm 31 carried by a diaphragm support 30 suitable for enabling the diaphragm to undulate in a fluid flow 32, each alternator 1 is mechanically connected by connection means 33 to the diaphragm so that during undulation the secondary and primary portions 3 and 2 of the alternator move relative to each other in the travel direction so as to generate an electric voltage across the terminals of the coil of the alternator; for each alternator, its secondary and primary portions are mechanically connected together by linear guide means for guiding these portions linearly relative to each another; and

FIG. 14 is a side view of the FIG. 13 turbine.

### DETAILED DESCRIPTION OF THE INVENTION

As mentioned above, the invention relates essentially to an alternator 1 comprising a magnetic primary portion 2 and a magnetic secondary portion 3 that are movable relative to each other in at least one travel direction 4.

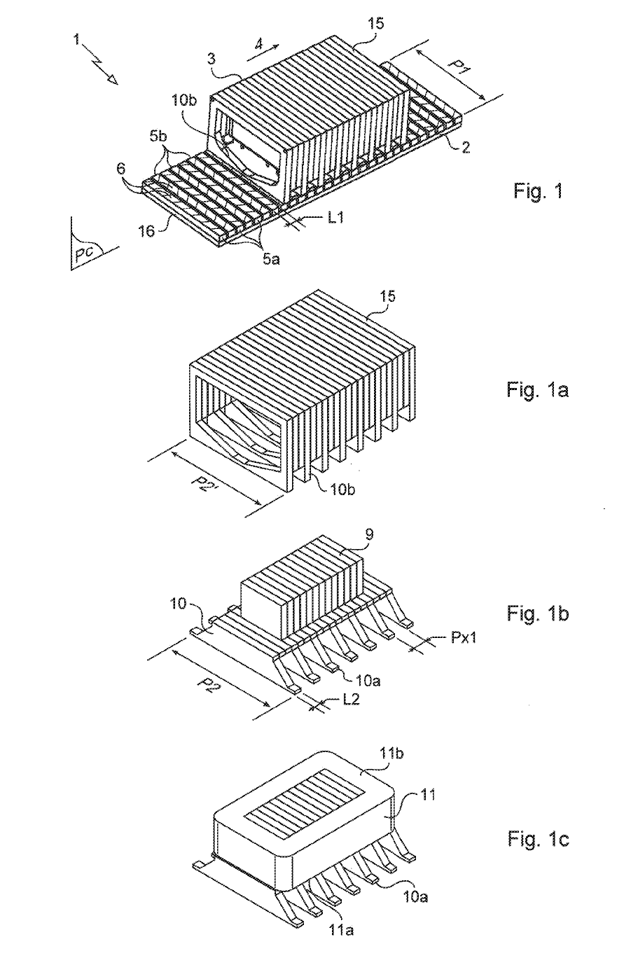

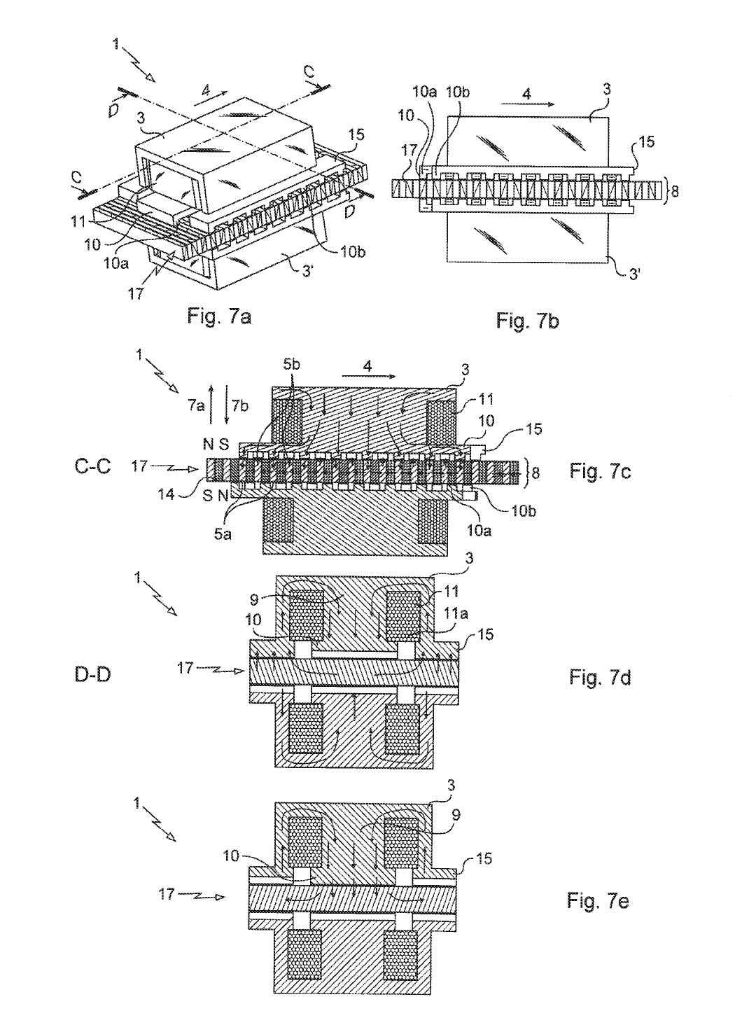

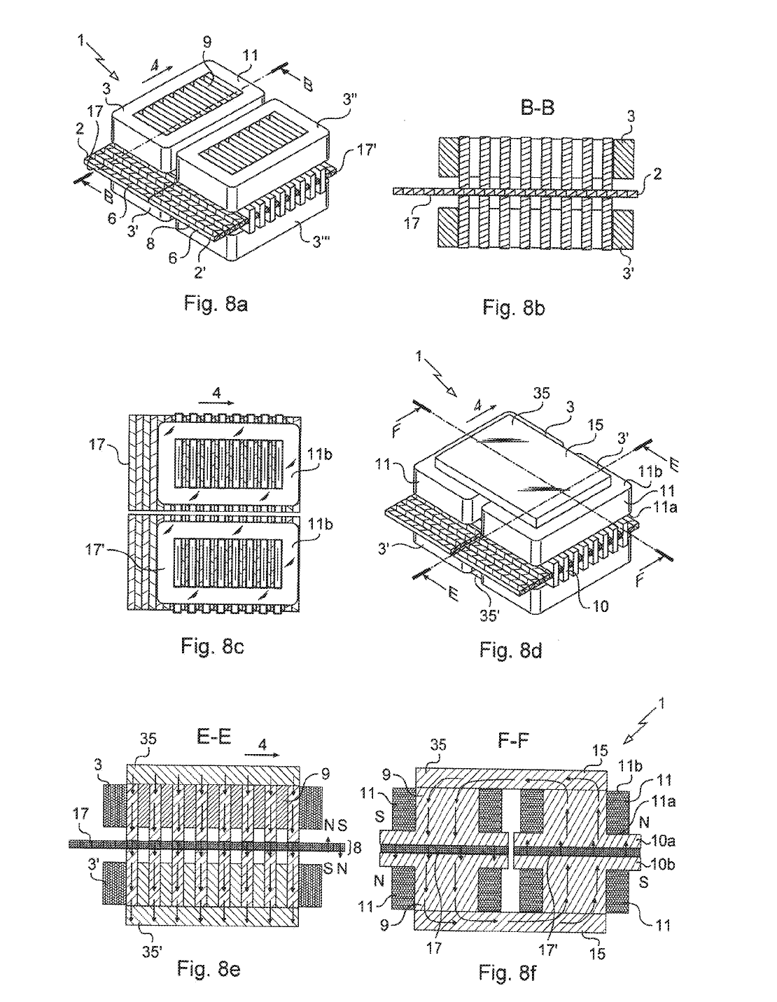

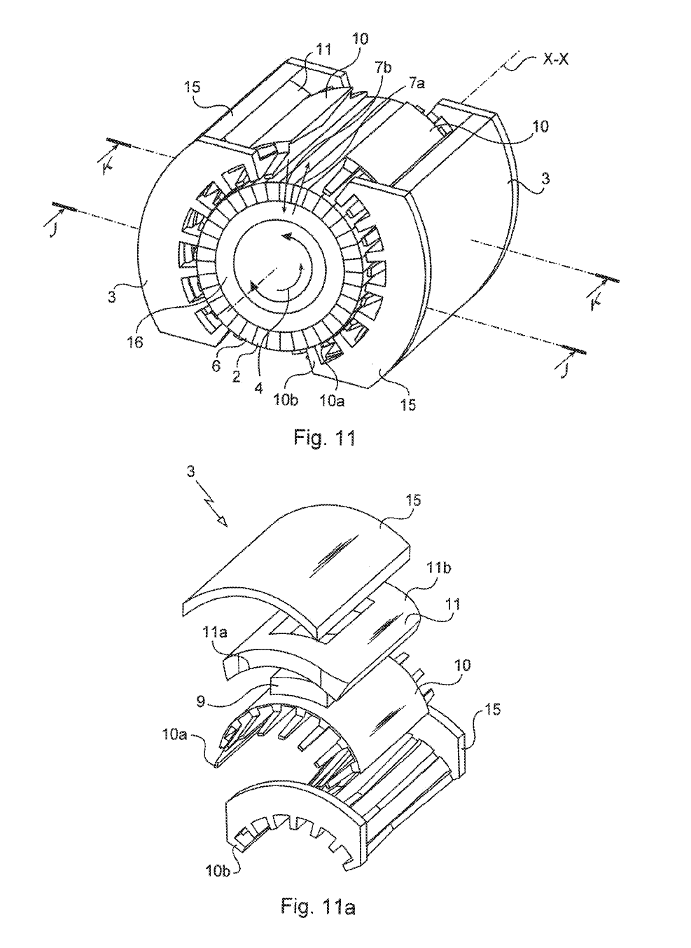

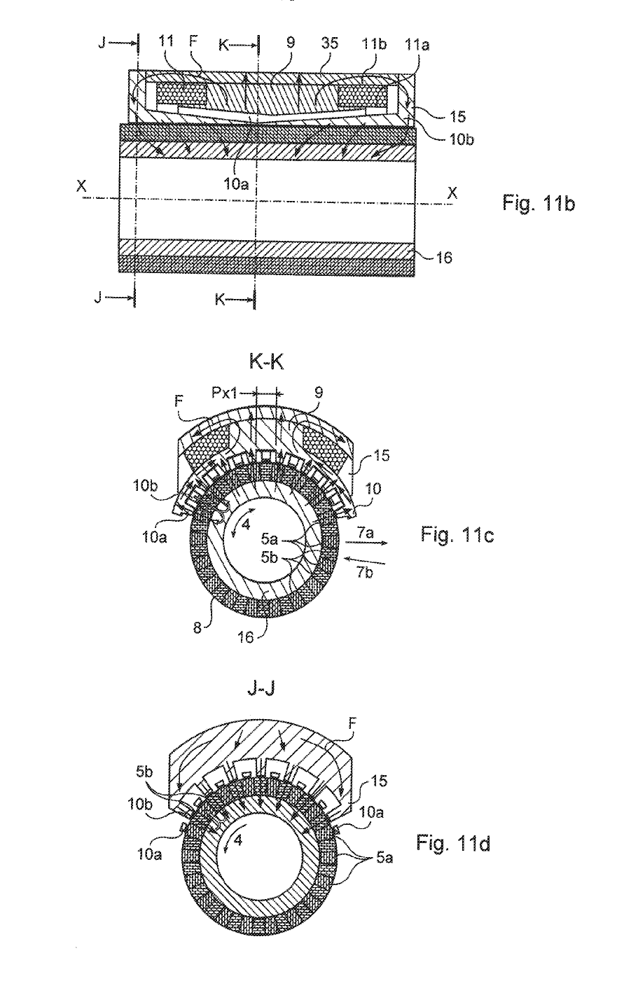

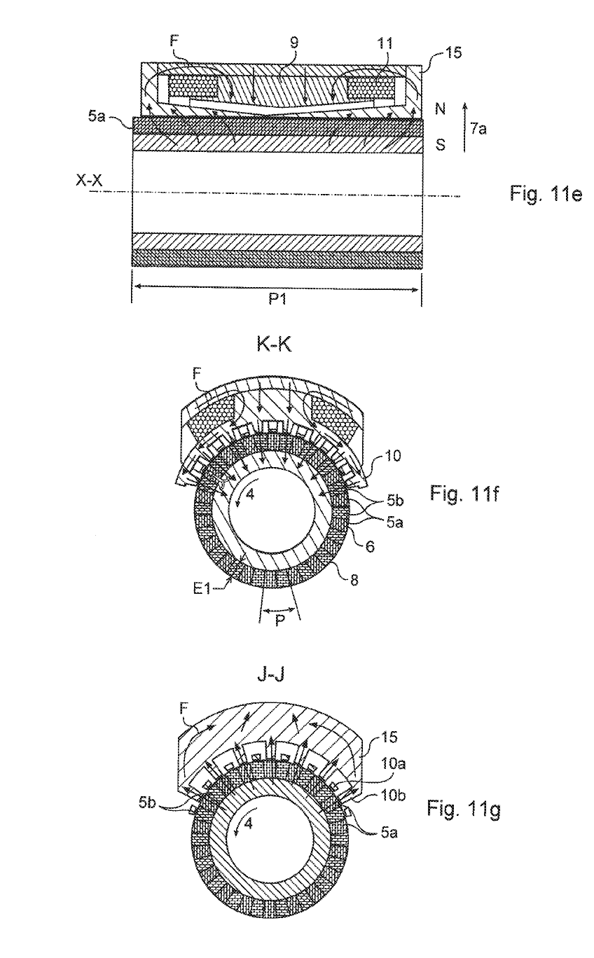

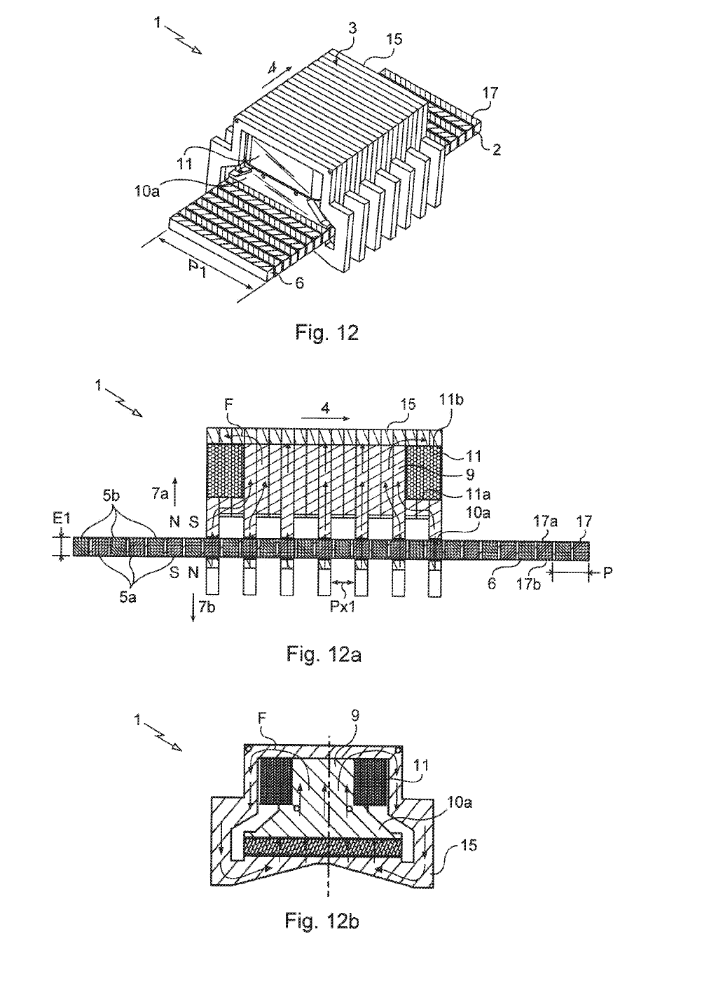

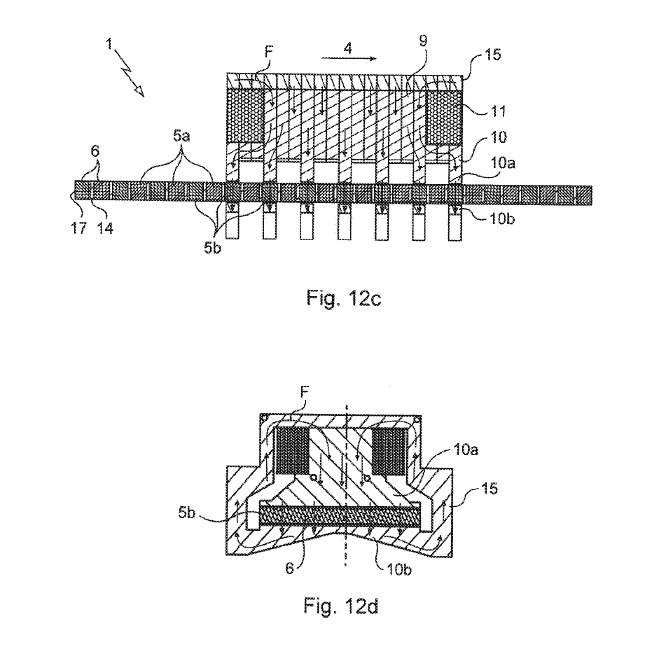

Depending on circumstances, this travel direction is either:
a rectilinear travel direction, as in FIGS. 1 to 10c and 12 to 14;
or a clockwise or counterclockwise direction as in FIGS. 11 to 11g. The secondary and primary portions are connected together by guide means for guiding these portions relative to each other.

When the travel direction 4 is a rectilinear travel direction, these guide means are linear guide means.

When the travel direction 4 is clockwise or counterclockwise, these guide means are rotary guide means.

In all embodiments of the invention, it can be seen that the primary portion 2 has first and second series 5a and 5b of magnets, with each of the magnets 6 in these series 5a and 5b of magnets having a north pole N and a south pole S.

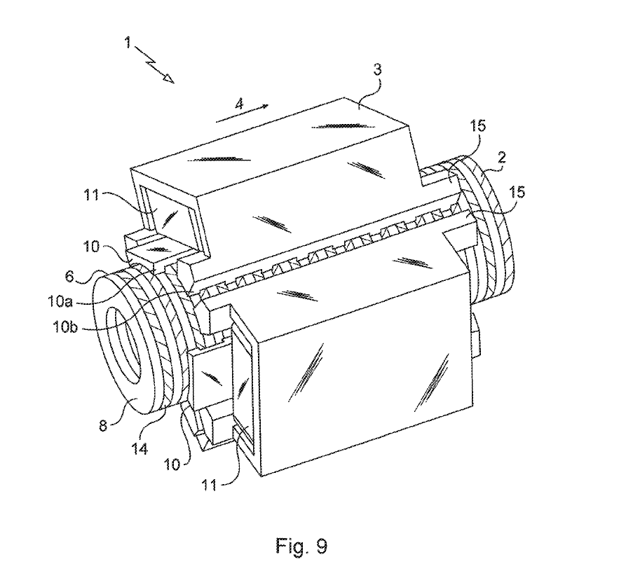

The magnets 6 of the first series 5a of magnets have their north poles N oriented in a first orientation direction 7a, which is either parallel for all of these magnets when the relative movement between the primary and secondary portions is linear (as in FIGS. 1 to 8f and 12 to 14), or else radially outwards when the relative movement comprises rotation (as in FIGS. 9 to 11g).

The magnets of the second series 5b of magnets have their north poles N oriented in the same second orientation direction 7b that is opposite to said first orientation direction 7a. Specifically, the magnets 6 of the second series 5b of magnets have their north poles N oriented in a second orientation direction 7b, which is:
either parallel for all of these magnets when the relative movement between the primary and secondary portions is linear (as in FIGS. 1 to 8f and 12 to 14);
or else radially inwards when the relative movement includes potential rotation (as in FIGS. 9 to 11g).

The magnets 6 of the first and second series 5a, 5b of magnets are arranged so as to form an alternation 8 of magnets of the first series 5a of magnets and of magnets of the second series 5b of magnets.

In all embodiments of the invention, it is found that the alternator has at least one secondary portion 3 having a core 9 and an electric coil 11 surrounding the core 9. This at least one secondary portion 3 has a first collector 10 that extends from the core 9 between a plane in which there extends a first pole face 11a of the coil 11 and at least some of the magnets 6 of the first and second series 5a, 5b of magnets.

This first collector 10 has teeth 10a spaced apart from one another so that during the movement of the secondary portion 3 relative to the primary portion 2 in said at least one travel direction 4, the alternator 1 adopts mutually distinct first and second configurations in alternation. It should be observed that a plurality of laminations may be stacked to form the teeth and the core. Alternatively, it is possible to form the assembly comprising the core and the collector(s) by molding a single part.

In the first configuration, the teeth 10a of the first collector 10 face respective magnets 6 belonging exclusively to the first series 5a of magnets.

In the second configuration, the teeth 10a of the first collector 10 face respective magnets belonging exclusively to the second series 5b of magnets.

The first collector 10 and the core 9 belong to the same magnetic assembly, i.e. an assembly in which magnetic flux forming a magnetic loop can circulate. As can be seen in FIGS. 1, 1b, 2a to 5d, and 7a to 12d, this collector 10 may be constituted by at least one projection from the core 9 extending on one side of the coil 11.

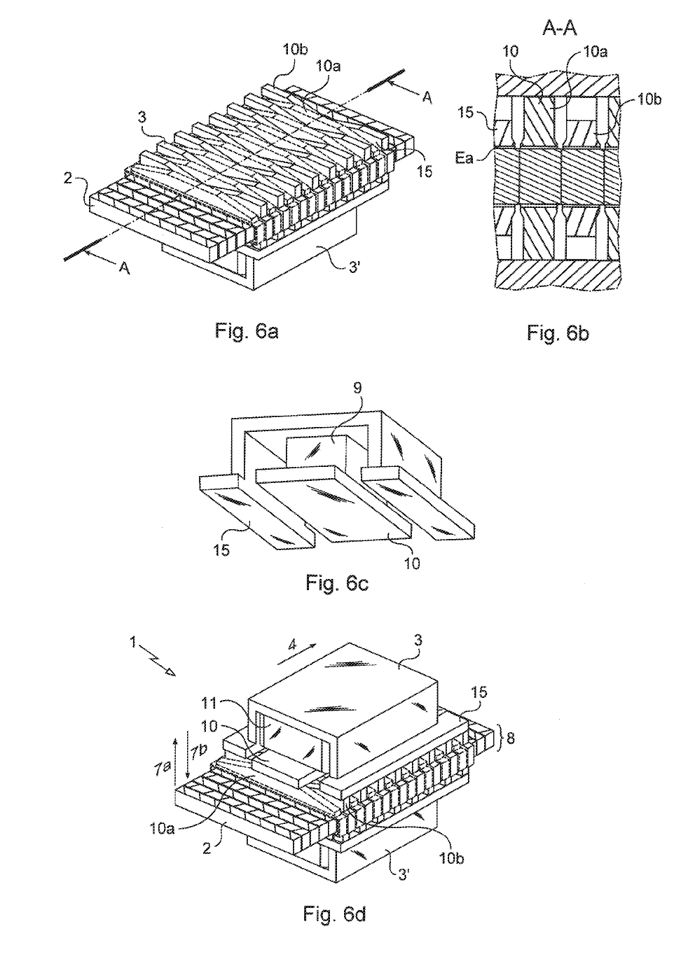

Alternatively, as can be seen in FIGS. 6a to 6d, the first collector 10 may be constituted by a magnetic part that is distinct from the core 9 and that is in contact against the core 9.

As can be seen in all of the embodiments described:
the teeth 10a of the first collector 10 are spaced apart from one another at a constant tooth spacing pitch, referred to as the first spacing pitch Px1;
the magnets of the first series 5a of magnets are spaced apart from one another at a constant spacing pitch for the magnets of the first series of magnets, referred to as the second spacing pitch Px2; and
the magnets of the second series 5b of magnets are spaced apart from one another at a constant spacing pitch for the magnets of the second series 5b of magnets, referred to as the third spacing pitch Px3.

It should be observed that the second and third spacing pitches Px1 and Px2 are equal to each other and the first spacing pitch Px1 is selected so that, at all times during the movement between the secondary and primary portions 3 and 2 relative to each other, every tooth 10a of the first collector 5a presents an instantaneous surface area facing a magnet of one of the series 5a, 5b of magnets, these instantaneous surface areas of the teeth 10a being identical to one another.

When the secondary and primary portions are free to move relative to each other in linear manner, these pitches Px1, Px2, and Px3 are distances.

When the secondary and primary portions are free to move relative to each other in rotary manner, these pitches Px1, Px2, and Px3 are angles.

As a result of these characteristics of the pitches Px1, Px2, and Px3, during travel at constant relative speed between the secondary portion 3 and the primary portion 1, it is found that the voltage across the terminals of the coil 11 varies with an alternating waveform of frequency and amplitude that are substantially constant. This alternating waveform is close to a triangular periodic signal. Furthermore, by means of these characteristics of the alternator 1, it is found that this alternating waveform for the voltage does not depend on the direction of relative travel between the secondary portion 3 and the primary portion 2, but depends only on the relative speed of this travel.

The alternator 1 of the invention thus presents operating symmetry that is independent of the relative travel direction 4 between the primary portion and the secondary portion. Thus, independently of the travel direction 4, the alternator produces the same voltage variation across the terminals of the coil 11. Consequently, the alternator may be connected to a mechanism for mechanically actuating the alternator to force it to reverse its travel direction cyclically.

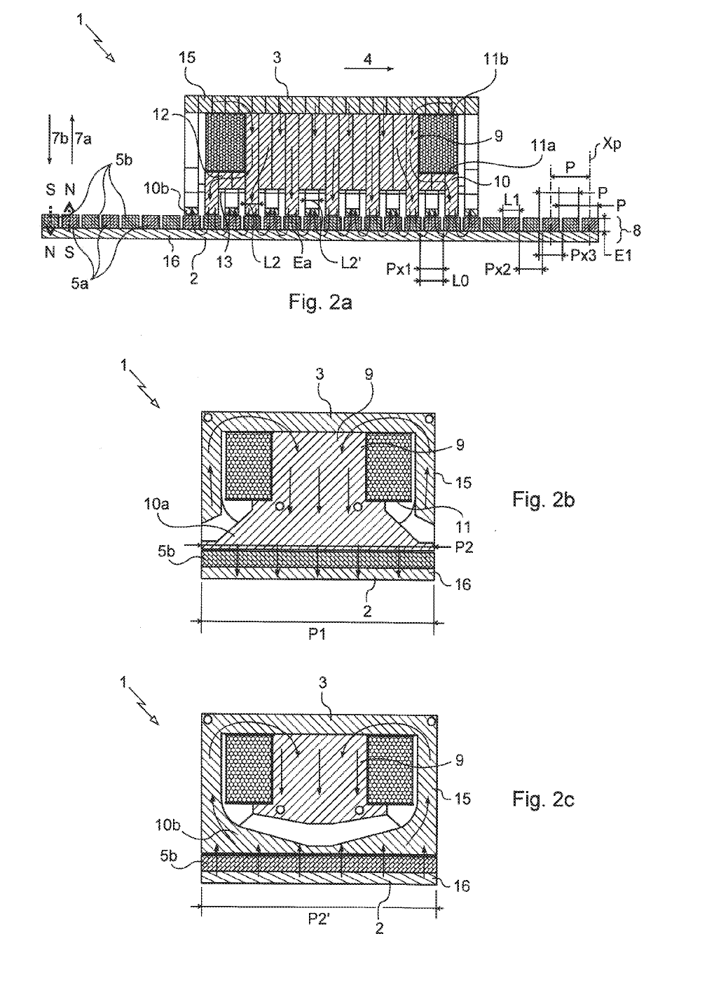

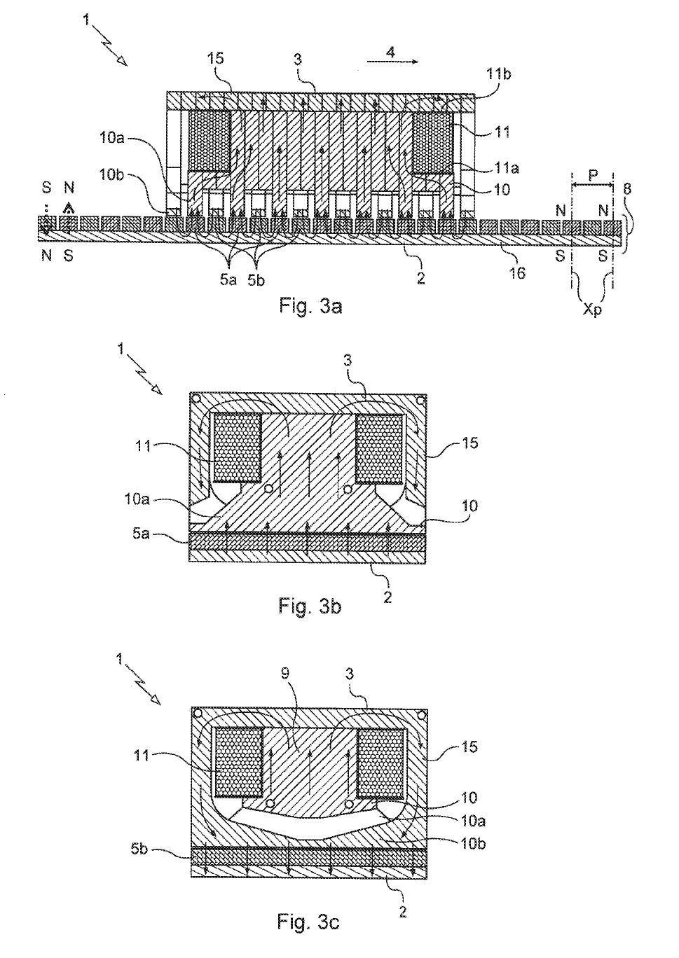

In all of the embodiments of the alternator 1, the first collector 10 presents a number of teeth 10a that is not less than six teeth, and the magnets 6 of the alternation 8 of magnets are spaced apart from one another in such a manner that:
when the alternator is in its first configuration (as shown in FIGS. 3a to 3c, 5a, 7c to 7e, 8e, 11b, 11c, 11d, 12a, 12b), each tooth 10a of the first collector faces a corresponding magnet of the first series 5a of magnets; and in such a manner that
when the alternator 1 is in its first configuration (as shown in FIGS. 2a to 2c, 5c, 10a to 10c, 11e to 11g, 12c to 12d), each tooth 10a of the first collector 10 faces a corresponding magnet 6 of the second series 5b.

Thus, regardless of the relative position between the secondary portion 3 and the primary portion 2, as soon as the alternator 1 is in one of its first and second configurations, it is found that the first collector always concentrates towards the core 9 a magnetic flux F coming from at least six magnets 6 of the same series, thereby improving the efficiency of the alternator.

In all embodiments of the invention, it can be seen that the teeth 10a of the first collector 10 and the magnets 6 of the first and second series 5a and 5b of magnets are arranged in such a manner that when the alternator 1 is in its first configuration or in its second configuration, each tooth 10a of the first collector arranged facing a corresponding magnet is spaced apart from that magnet by an air gap. As shown in particular in FIGS. 2a and 6b, all of these air gaps are of the same shape and the air gap distance Ea is uniform over the entire depth of the air gap. Ideally, the teeth of the first collector and the magnets are shaped so that every tooth of the first collector facing a given magnet extends parallel to that given magnet, the air gap thus being constant over the entire depth of the tooth.

In the embodiments shown in FIGS. 1, 2a to 8f, 11 to 11d, the magnets of said first and second series 5a and 5b of magnets all have the same bar shape. Each bar-shaped magnet presents a bar length, referred to as the magnet depth P1, and a bar thickness referred to as the magnet thickness E1. In these embodiments, each north and south pole N and S of a given magnet 6 extends along the bar-shape, i.e. along the depth P1, these north and south poles being spaced apart from each other by the thickness E1 of the bar.

Ideally, each tooth 10a of the first collector presents the same tooth width L2 and the same tooth depth P2, with it being possible for there to be variation in its height only. Each tooth 10b of the second collector presents the same tooth width L2′ and the same tooth depth P2′, with it being possible for there to be variation in its height only. The tooth widths L2 and L2′ are identical to each other, and preferably the tooth lengths P2 and P2′ are also identical to each other. The tooth depths P2 and P2′ are parallel to the depths P1 of the bar-shaped magnets. Each magnet presents a magnet width L1 measured perpendicularly to its thickness E1. The teeth 10a of the first collector are mutually uniform in terms of dimensions. The teeth 10b of the second collector are mutually uniform in terms of dimensions. The magnets of the first and second series 5a and 5b of magnets are mutually uniform in terms of dimensions. The width l1 of the magnets is greater than the widths L2 and L2′ of the teeth of the first and second collectors respectively.

The alternator 1 has guide means for guiding the secondary portion relative to the primary portion and arranged to guide relative travel 4 between the secondary portion 3 and the primary portion 2. These guide means are such that during relative travel between the secondary portion and the primary portion, every tooth of the first or second collector placed facing a magnet presents its tooth depth P2, P2′ parallel to the depth P1 of the magnet that it faces. The tooth depths P2 should ideally be equal to the magnet depths P1 so that the magnetic flux travels along the entire length of the tooth and along the entire length of the magnet.

More precisely, in the embodiments of FIGS. 1 to 8f and 9, 10, 10a, 10b, 10c, 12, 12a, 12b, 12c, 12d, 13, and 14, the guide means comprise means for providing guidance to move in linear translation (not shown), which means are arranged to provide guidance in a rectilinear translation in a rectilinear travel direction of the secondary and primary portions relative to each other, the travel direction 4 being a direction parallel to this rectilinear travel direction.

In these figures, the first orientation direction 7a, which goes from the south pole S to the north pole N for each magnet of the first series of magnets, is oriented perpendicularly to the rectilinear travel direction 4. The second orientation direction 7b, which goes from the south pole S to the north pole N for each magnet of the second series of magnets, is oriented perpendicularly to the rectilinear travel direction 4, and it is opposite to the first direction 7a.

In the embodiments of FIGS. 11, 11a, 11b, 11c, 11d, 11e, 11f, and 11g, the guide means comprise rotary guide means (not shown) about an alternator axis of rotation X-X of the alternator. Under these circumstances, the travel direction 4 is a clockwise direction or a counterclockwise direction. In these embodiments, the magnets of the first and second series of magnets have their north poles oriented radially relative to the axis of rotation X-X.

For each magnet of the first series of magnets, the first orientation direction 7a goes from the south pole S towards the north pole N, and it is outwardly directed.

For each magnet of the second series of magnets, the second orientation direction 7b goes from the south pole S towards the north pole N, and it is inwardly directed.

In particular embodiments of the invention, shown in FIGS. 2a, 3a, 5a to 5d, 6b, 7a, 7c, 8b, 8e, 10a, 12a, and 12c, it can be seen:
that the teeth 10a of the first collector 10 are arranged to extend from the core 9 towards the alternation 8 of magnets of the first and second series 5a, 5b of magnets;
that the first collector 10 has spacers 12 arranged to maintain the spacing between the teeth 10a, these spacers 12 and teeth 10a of the first collector 10, when observed in a longitudinal section plane Pc of the alternator 1 that is parallel to said travel direction 4, forming a crenellated profile extending facing the alternation 8 of magnets;
that each crenellation of the crenellated profile of the first collector 10 presents a crenellation width L0 that corresponds to the distance between two adjacent teeth of the crenellation, and each tooth 10a of the first collector 10 presents a tooth width L2 corresponding to a dimension of the tooth 10a measured between two crenellations adjacent to the tooth 10a; and
that each magnet 6 of the alternation 8 presents a magnet width L1 corresponding to a dimension of the magnet 6 measured in the longitudinal section plane Pc of the alternator 1 in a direction perpendicular to a polar axis Xp containing the poles N and S of the magnet, and each crenellation width L0 is greater than any one of the magnet widths L1 of the alternation 8 of magnets.

In other words, as shown in FIGS. 2a, 3a, 5a to 5d, 6b, 7a, 7c, 8b, 8e, 10a, 12a, and 12c, the teeth 10a of the first collector 10, when observed in the longitudinal section plane Pc of the alternator 1, form a profile that is crenellated. The magnets of the first and second series 5a and 5b of magnets extend perpendicularly to this plane Pc so that during relative travel between the primary portion 2 and the secondary portion 3, the magnets 6 move along with the crenellated profile and pass in alternation in front of the crenellations and in front of the teeth 10a. Since the width L0 of the crenellations is strictly greater than the width L1 of the magnets, it is not possible at any time for a magnet to be facing two teeth 10a of the first collector 10 simultaneously.

In this particular embodiment, the magnets 6 of the first and second series 5a and 5b may all present the same magnet width L1, with the crenellations all presenting the same crenellation width L0, with the teeth 10a of the first collector 10 all presenting the same tooth width L2, and with the tooth width L2 of the first collector 10 being strictly less than the magnet width L1.

For given tooth width and tooth pitch, this characteristic serves to maximize the volume of the magnets and thus to maximize the flux F that can potentially be collected by the teeth.

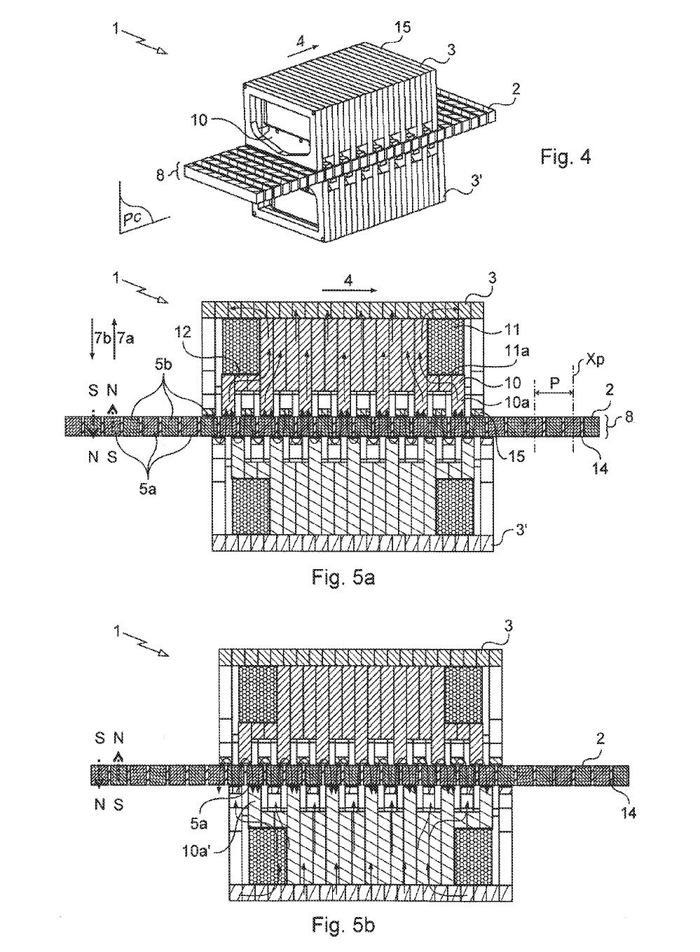

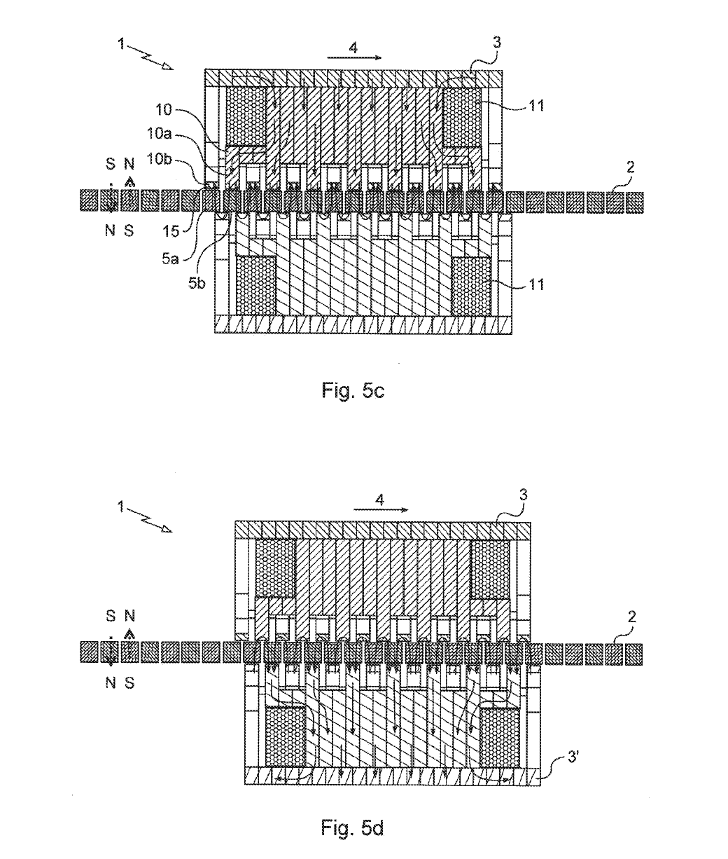

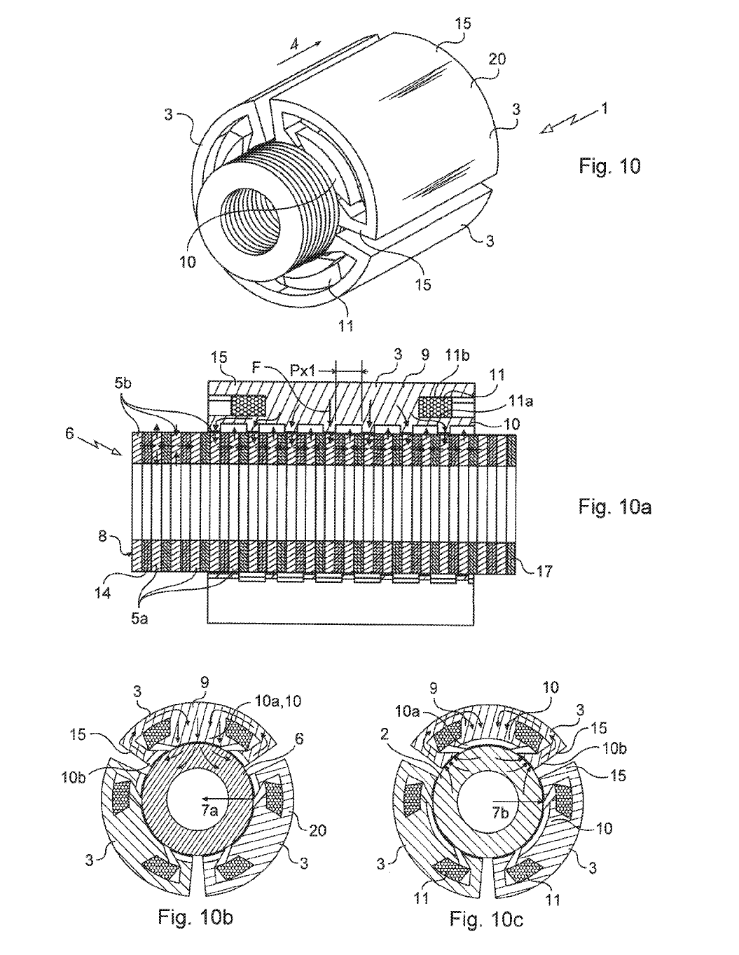

Embodiments in which the alternator presents a plurality of secondary portions 3, 3′ placed on either side of the magnet track 17, as in FIGS. 4, 5a, 5b, 5c, 5d, these secondary portions 3, 3′ are preferably offset relative to one another by one fourth of the pole pitch p so that when one of the secondary portions is in the first or second configuration, then the magnetic flux F passing through its core 9 is looped by the presence of teeth in the other secondary portion that are offset by one fourth of the pole pitch p. This can be seen in FIGS. 5a, 5b, 5c, 5d. This offset can also be applied to the rotary variants of the alternator as shown in FIGS. 11 to 11g. It should be observed that when there are three secondary portions connected together and facing a common primary portion, as in FIG. 10, the offset between the teeth of the secondary portions may be one third of the pole pitch p in order to enable three-phase AC to be generated.

The alternator of FIGS. 5a, 5b, 5c, 5d has a plurality of secondary portions 3, 3′ referred to respectively as first and second secondary portions 3, 3′, these secondary portions being mechanically connected together so as to move together along said travel direction 4. The first collectors 10a, 10a′ of these first and second secondary portions 3, 3′ are such that when the teeth of one of these first collectors 10a, 10a′ are facing magnets 6 belonging exclusively to the first series 5a of magnets or to the second series 5b of magnets, then the teeth of the other one of these first collectors 10a, 10a′ are offset relative to the magnets of the first or second series of magnets by an offset value:
that is greater than one eighth of the pole pitch p of the alternation of magnets; and that is preferably equal to one fourth of the pole pitch p of the alternation of magnets.

This offset makes it possible to limit the maximum magnetic force opposing travel of the primary portion 2 relative to the first and second secondary portions 3, 3′.

The magnets of the alternation are of uniform shape and the pole pitch p corresponds to the distance between two successive pole axes Xp of the same series of magnets.

The pole axis Xp of a magnet is the axis passing through its south and north poles S and N.

In the particular circumstance of the embodiments shown, in which the magnets of the series have the same uniform shape, it is found that the pole pitch p also corresponds to twice the magnet width L1 measured in the travel direction 4 plus twice the distance between two adjacent magnets of the alternation of magnets. The distance between two adjacent magnets of the alternation generally corresponds to the thickness of the spacers 14 that are interposed between the adjacent magnets of the alternation of magnets. The spacers 14 are also of mutually uniform shape.

It should be observed that the collectors 10, 15 and the core may be made of a material suitable for providing magnetic looping, such as iron, an iron/silicon alloy, and/or an iron cobalt alloy. Preferably, these elements are in slices of the material separated in the plane of the magnetic loop, and these slices are insulated from one another, at least at certain locations, e.g. by an electrically-resistive varnish.

Typically, the magnets used in the alternator of the invention are:
made of neodymium/iron/boron alloy or of samarium/cobalt alloy, thus making it possible to have high-energy magnets; or
made of light alloy or of aluminum/nickel/chromium alloy, thus making it possible to have magnets that are less expensive but of lower energy.

The coils are made of copper wire or of wire comprising copper with an aluminum core or of a graphene type material, or out of silver-coated copper wire.

In general manner, the section of the teeth as seen in section planes parallel to the orientation directions 7a, 7b of the poles may increase on going along the magnetic flux path passing via the tooth towards the core 9. In particular, each of the teeth of the first and second collectors presents a tooth section as seen in section planes of the tooth parallel to said first and second orientation directions 7a, 7b that increase on going along the magnetic flux path passing via the tooth towards the core 9. This can be seen in particular for the teeth 10a in FIG. 1c or 11a for which height increases on coming closer to the core 9. This can also be seen through the teeth 10b of FIGS. 2c and 11b for which height increases on going along with the magnetic flux path towards the core 9. This increase in height makes it possible to increase section, thereby enabling the shape of the tooth to be optimized so as to minimize its weight, while limiting any risk of magnetic saturation or of magnetic field leakage.

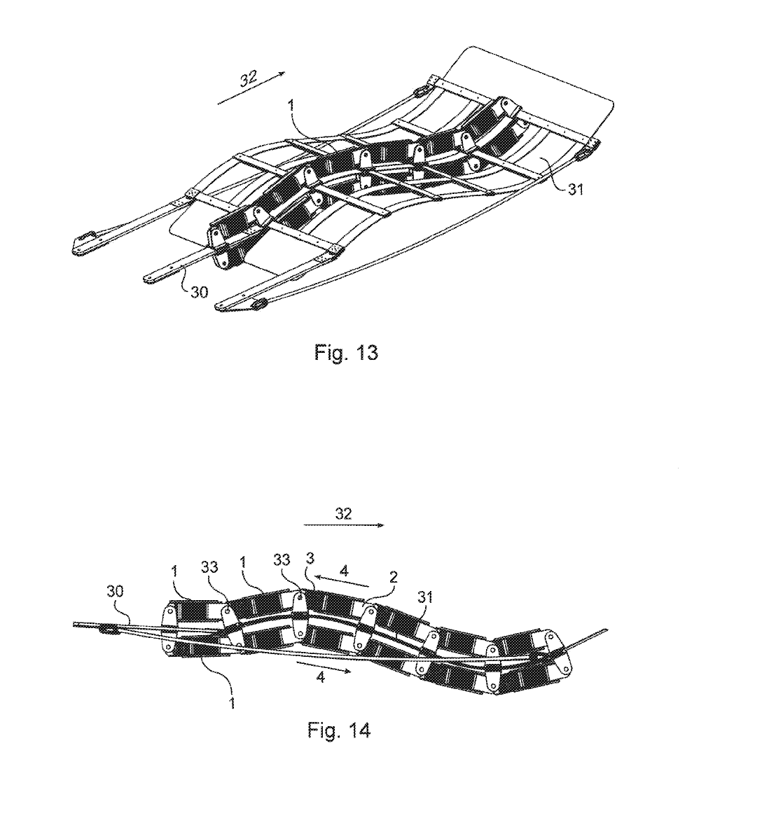

As mentioned above and as shown in FIGS. 13 and 14, the invention finally relates to an underwater turbine comprising a diaphragm support 30 carrying a diaphragm 31 that is arranged to undulate when it is immersed in a fluid flow 32. The diaphragm 31 is mechanically connected to at least one alternator 1 of at least one of the embodiments of the invention. This connection 33 between the diaphragm 31 and said at least one alternator 1 is such that when the diaphragm 31 undulates, it generates relative travel between the primary and secondary portions 2 and 3 of this at least one alternator 1 so as to generate an electric voltage across the terminals of the coil 11 of the alternator.

In FIG. 14, it can be seen that the alternators 1 form two groups of alternators arranged facing respective opposite faces of the diaphragm. Each alternator is connected to the diaphragm firstly via a first lever 33 extending from a location on the diaphragm 31 to a hinge carried by the secondary portion 3 of the alternator 1, and secondly via a second lever 33 extending from another location on the diaphragm 31 to a hinge carried by the primary portion 2 of the alternator 1. Each alternator group is made up of a plurality of alternators that are aligned substantially parallel to the preferred undulation direction of the diaphragm 31, which means that as a wave propagates along the diaphragm, the levers move with the diaphragm and the ends of the levers carrying a given alternator either move towards each other or else away from each other. The alternator carried by a pair of levers thus tends to generate electricity under the effect of the relative travel between its secondary and primary portions. During this travel, the alternator alternates in succession between its first and second configurations and generates an alternating voltage across the terminals of its coil; it can be seen that for any given alternator of the turbine, the relative travel direction 4 between the primary portion and the secondary portion reverses periodically, thereby enabling the alternator to produce an alternating voltage in each of the travel directions 4. It should be observed that the groups of alternators may be arranged in such a manner that the alternators are placed symmetrically relative to the diaphragm so that when the diaphragm is curved, the alternator that is on the inside of the curvature is shortened while the alternator that is on the outside is lengthened. It is also possible for the groups of alternators situated facing the opposite faces of the diaphragm to be offset in such a manner that when the undulation travels along the diaphragm, two facing alternators on opposite sides of the diaphragm are never simultaneously at the ends of their strokes. The term “end of stroke” of an alternator is used to mean the position adopted by the alternator when the travel direction of its secondary and primary portions reverses, either in order to lengthen or else in order to shorten the alternator. This is useful for making it easier to initiate wave propagation along the diaphragm.

This turbine may include a converter circuit that is remote from the alternators 1, at least some of the coils of the alternators are electrically connected to the converter circuit via conductors of electricity. The converter circuit is then arranged so that it takes the electrical voltages generated by at least some of the coils 11 that are connected thereto and generates output electricity at output terminals of this at least one remote converter circuit.

Such a converter circuit enables the turbine to continue to operate even if some of the coils that are connected to the converter are faulty. The turbine can thus continue to operate in a degraded mode without that requiring a maintenance operation.

Another advantage of this converter circuit is that it enables the electrical energy coming from a plurality of coils to be accumulated so as to deliver electrical power that is regulated and greater than the electrical powers individually produced by the coils 5.

It should be observed that these alternators may be arranged on one face only or on both faces of the diaphragm.

When the converters 2 are arranged on opposite faces of the diaphragm, they are preferably aligned in planes parallel to the longitudinal section plane of the diaphragm and they are arranged symmetrically relative to said plane, lying at equal distances from the sides of the diaphragm.

It is also possible for the coils of the alternators to be connected to the converter circuit in order to generate polyphase electricity.

1. An alternator comprising a magnetic primary portion and a magnetic secondary portion that are movable relative to each other in at least one travel direction:
the primary portion comprising first and second series of magnets, each of the magnets of the series of magnets comprising a north pole and a south pole, the magnets of the first series of magnets having their north poles oriented in the same first orientation direction, the magnets of the second series of magnets having their north poles oriented in the same second orientation direction opposite to said first orientation direction, the magnets of the first and second series of magnets being arranged in such a manner as to form an alternation of magnets from the first series of magnets and from magnets of the second series of magnets;
the secondary portion comprising a core and a coil surrounding said core, the alternator being characterized in that the secondary portion presents a first collector extending from the core between a plane in which there extends a first pole face of the coil and at least some of the magnets of the first and second series of magnets, the first collector having teeth spaced apart from one another in such a manner that during travel of the secondary portion relative to the primary portion along said at least one travel direction, the alternator adopts in alternation first and second mutually distinct configurations, the teeth of the first collector, when in the first configuration, facing respective magnets belonging exclusively to the first series of magnets, and the teeth of the first collector, when in the second configuration, facing respective magnets belonging exclusively to the second series of magnets, wherein the core is arranged inside the coil, the first collector extending outside the coil, a central portion of the first collector being situated between the core and some of the magnets of the first and second series of magnets and two side portions of the first collector being arranged respectively on either side of the central portion of the first collector, these side portions facing the first pole face of the coil between the coil and the magnets of the first and second series of magnets, each central or side portion of the first collector carrying at least one of the teeth of the first collector.

2. The alternator according to claim 1, wherein:
the teeth of the first collector are spaced apart from one another at a constant tooth spacing pitch, referred to as the first spacing pitch;
the magnets of the first series of magnets are spaced apart from one another at a constant spacing pitch for the magnets of the first series of magnets, referred to as the second spacing pitch; and
the magnets of the second series of magnets are spaced apart from one another at a constant spacing pitch for the magnets of the second series of magnets, referred to as the third spacing pitch.
the second and third spacing pitches being equal to each other and the first spacing pitch being such that at each instant during travel of the secondary and primary portions relative to each other, each tooth of the first collector presents an instantaneous surface area facing a magnet of one of the series of magnets, these instantaneous surface areas being mutually identical.

3. The alternator according to claim 1, wherein the first collector presents a number of teeth that is not less than six teeth, and the magnets of the alternation of magnets are spaced apart from one another in such a manner that when the alternator is in its first configuration, each tooth of the first collector faces a corresponding magnet of the first series of magnets, and in such a manner that when the alternator is in its second configuration, each tooth of the first collector faces a corresponding magnet of the second series of magnets.

4. The alternator according to claim 1 wherein the teeth of the first collector are arranged to extend from the core towards the alternation of magnets of the first and second series of magnets, the first collector having spacers arranged to maintain a spacing between these teeth, the spacers and the teeth of the first collector, when observed in a longitudinal section plane of the alternator that is parallel to said travel direction, forming a crenellated profile that extends facing the alternation of magnets, each crenellation of the crenellated profile of the first collector presents a crenellation width that corresponds to the distance between two teeth adjacent to the crenellation, and each tooth of the first collector presents a tooth width corresponding to a dimension of the tooth measured between two correlations adjacent to the tooth, each magnet of the alternation presenting a magnet width corresponding to a dimension of the magnet measured in the longitudinal section plane of the alternator in a direction perpendicular to the pole axis passing through the north and south poles of the magnet, each crenellation width being greater than any of the magnet widths of the alternation of magnets.

5. The alternator according to claim 4, wherein the magnets of the first and second series all present the same magnet width, the crenellations all present the same crenellation width, and the teeth of the first collector all present the same tooth width, the tooth width of the first collector being technically less than the magnet width.

6. (canceled)

7. The alternator according to claim 1, wherein the coil has a second pole face, the first and second pole faces of the coil being situated on either side of the coil, the alternator further including a second collector extending around the coil from a side of the core situated beside the second pole face of the coil, a portion of the second collector having teeth spaced apart from one another in such a manner that when the alternator is in one of said first and second configurations, the teeth of the second collector then respectively face magnets belonging exclusively to one of said series of magnets, the teeth of the first and second collectors also being shaped in such a manner that when the teeth of the first collector face exclusively north poles of the magnets, then the teeth of the second collector then face exclusively south poles of the magnets, and vice versa.

8. The alternator according to claim 7, wherein the teeth of the second collector extend between the first pole face and a face of the alternation of magnets of the first and second series of magnets, the teeth of the second collector being spaced apart from the teeth of the first collector, and the teeth of the second collector extending between the teeth of the first collector in such a manner that when the alternator is placed in either one of its first and second configurations, the teeth of the first collector face magnets belonging to one of said first and second series of magnets, the teeth of the second collector then facing magnets belonging to the other one of said first and second series of magnets.

9. The alternator according to claim 7, wherein the magnets of the first and second series of magnets are both placed on a magnetically permeable part, the north poles of the magnets of the first series of magnets and the south poles of the magnets of the second series of magnets facing the magnetically permeable part.

10. The alternator according to claim 7, wherein each of the teeth of the first and second collectors presents a tooth section as seen in section planes of the tooth parallel to said first and second orientation directions that increases on going along the magnetic flux path passing via the tooth towards the core.

11. The alternator according to claim 7, wherein each tooth of the second collector is formed along a peripheral portion of a corresponding lamination of closed annular shape, whereas each tooth of the first collector is formed at the end of a corresponding lamination that is plane and of constant thickness, the lamination becoming wider on going from the core towards the end of the tooth.

12. The alternator according to claim 7, wherein the magnets of the first and second series of magnets form a magnet track presenting first and second opposite faces of the magnet track, the teeth of the first collector being situated facing the first face of the magnet track, and the teeth of the second collector being situated facing the second face of the magnet track, and the teeth of the first and second collectors being shaped in such a manner that when the alternator is in one of its first and second configurations, the teeth of the first and second collectors then face magnets belonging to the same one of said first and second series of magnets.

13. The alternator according to claim 1, wherein the coil is wound around the core and is rectangular in shape when seen in section in a plane perpendicular to the direction of the magnetic flux passing through the core when the alternator is in one of its first and second configurations.

14. The alternator according to claim 13, wherein the core is rectangular in shape when seen in section in the plane perpendicular to the direction of the magnetic flux passing through the core when the alternator is in one of its first and second configurations.

15. The alternator according to claim 1, having a plurality of secondary portions, the secondary portions respectively being referred to as the first and second secondary portions, these secondary portions being mechanically connected together so as to travel together in said travel direction, the first collectors of these first and second secondary portions being such that when the teeth of one of these first collectors are facing magnets belonging exclusively to the first series of magnets or to the second series of magnets, then the teeth of the other one of the first collectors are offset relative to the magnets of the first or second series of magnets by an offset value that is greater than one eighth of the pole pitch of the alternation of magnets, and preferably equal to one fourth of the pole pitch of the alternation of magnets, this offset serving to limit the maximum magnetic force opposing travel of the primary portion relative to the first and second secondary portions, the pole pitch corresponding to the distance between two pole axes of successive magnets of the same series of magnets.

16. An underwater turbine comprising a diaphragm support carrying a diaphragm arranged to undulate when it is immersed in a fluid flow, the turbine being characterized in that the diaphragm is mechanically connected to at least one alternator according to claim 1, the connection between the diaphragm and said at least one alternator being such that when the diaphragm undulates, it generates relative travel between the primary and secondary portions of the at least one alternator.
